(19) United States
(12) Patent Application Publication
(10) Pub. No.: US 2011/0198835 A1
(43) Pub. Date: Aug. 18, 2011

(54) Insertable tab divider with special opening

(76) Inventor: Lim Soon Huat, Georgetown (MY)

(21) Appl. No.: 12/656,742

(22) Filed: Feb. 16, 2010

(51) Int. Cl. B42D 9/00

(52) U.S. Cl. 281/42

(57) ABSTRACT

A divider sheet may consist of a label insert and a divider sheet with a pair of side edges. A tab is attached to at least one of side edges. The tab includes a tab section projecting out from at least one of the side edges in which the tab is attached to and a pocket section that is at least partially adhered to the tab section. The tab section and the pocket section form a pocket with an opening horizontally at the top of the tab and extending partially along at least one of the edges adjoining to the opening such that it forms a flap that is able to be flipped open from the divider sheet at the top of the pocket's opening which eases the insertion and removal of a label insert into the pocket.

### CROSS-REFERENCE TO RELATED APPLICATIONS

| | | |
|---|---|---|
| 943720 | December 1909 | Vick |
| 958050 | May 1910 | Whipple |
| 1705753 | March 1929 | Dawson |
| 3205597 | September 1965 | Stern |
| 4516871 | May 1985 | Leitman |
| 4784508 | November 1988 | Shannon |
| 5135261 | August 1992 | Cusack |
| 5875579 | March 1999 | Winzen |
| 5743566 | December 1999 | Hunter |
| 6390715 | May 2002 | Gerbasi |
| 7125050 | October 2006 | Yamamoto |

### STATEMENT REGARDING FEDERALLY SPONSORED RESEARCH OR DEVELOPMENT

Not Applicable

### REFERENCE TO SEQUENCE LISTING A TABLE, OR A COMPUTER PROGRAM LISTING COMPACT DISC APPENDIX

Not Applicable

### BACKGROUND OF THE INVENTION

One of the most common and widely used indexing systems is the index divider sheets with insertable tabs carrying index labels for organizing and grouping of different types of documents. For example, reference may be made to the following U.S. Pat. Nos. 943,720, 958,050, 1,705,753, 3,205,597, 4,784,508, 6,390,715, 5,875,579, 5,135,261, 5,743,566, 4,516,871 and 7,125,050.

Conventionally, a typical insertable index divider sheet consists of a rectangular tab adhered to a side edge of a piece of divider sheet. FIG. 1 and FIG. 2 shows a typical insertable divider sheet 100 with a tab 101. The tab 101 is closed along the periphery of two side edges and has openings on the top and bottom defining the enclosed pocket 103 so that an index label 104 carrying the index indicia can be inserted into the pocket 103 of the tab 101 in the longitudinal direction L or vertically as shown by arrows A and B. To simplify this discussion, the direction perpendicular to the top edge of a divider sheet and parallel to the side edges of a divider sheet will be regarded as the longitudinal direction L while the direction parallel to the top edge of a divider sheet and perpendicular to the side edges will be regarded as the transverse direction T.

Although such dividers are of great convenience, they are with a number of drawbacks. One of the problems associated with such dividers is that the job of inserting and removing the index label 104 can be very difficult and time consuming because of the tight tolerances at the top and bottom opening of the pocket 103. Also, the index label 104 can be easily bended, creased or damaged during the insertion. The label 104 can also fall out from the tab especially when the file containing such a divider sheet 100 is kept in an upright position.

The present invention relates to a new design of the insertable tab that enables user to insert and remove the insert labels easily and prevents the insert labels from falling out from the tabs. Also, it allows multiple shapes and sizes of tabs and matching labels other than the conventional rectangular shape of tabs and labels. Furthermore, it permits more text and information to be printed on the insert label.

### BRIEF SUMMARY OF THE INVENTION

Therefore, the objective of the present invention is to provide a design for the insertable tab index divider sheet wherein the opening of the tab's pocket is designed uniquely to provide users a more user friendly and easier way to insert and remove the index label from the tab. The present invention relates to a divider sheet with a label insert or set of insertable tab divider sheets and the label inserts sheet used together with the tabs.

A divider sheet has a top edge, a bottom edge and a pair of side edges. A tab is attached to the side edge and extending out from the side edge of the sheet with an opening. However, unlike the conventional insertable tab divider sheet wherein the tab is totally closed along the periphery of the side edges and has openings on the top and bottom defining the enclosed pocket, the present invention has its tab opened not only on the top but extending partially along at least one of the edges adjoining to the top such that it forms a flap that is able to be flipped open from the divider sheet at the top of the pocket's opening. This unique design of the tab's opening enables user to insert and remove the insert labels easily and minimizes damages such as creasing lines to the label inserts during insertion and removal.

The bottom of the tab and the edges adjacent to it may be sealed or closed up to the opening of the tab so that a label will not fall out from the tab especially when the file containing the divider is kept in an upright. Alternatively, the bottom of the tab may be partially sealed or of a smaller width compared to the top of the tab so that it would prevent a label from falling out from the tab.

In still other embodiment, the design of the tab opening may be applied to the conventional insertable index divider.

Another advantage of this new design is that the tab is not only limited to rectangle shape but it allows various shapes with matching label. Hence, the label insert may be designed with a larger writing or printing area so that the amount of information that can be printed onto the label insert will not be as limited as compared to the conventional insertable divider sheet.

### BRIEF DESCRIPTION OF THE SEVERAL VIEWS OF THE DRAWING

FIG. 1 is a top perspective view of a conventional insertable index divider;

FIG. 2 is a cross sectional view of line 2-2 of FIG. 1;

FIG. 3 is a plan view of an insertable index divider which is made in accordance with the present invention;

FIG. 4 is an enlarged fragmentary view of an insertable index divider according to one of the embodiment of an insertable index divider sheet;

FIGS. 5a, 5b, 5c and 5d is a cross sectional view of line 5-5 of FIG. 4;

FIGS. 6a, 6b, 6c and 6d is a cross sectional view of line 6-6 of FIG. 4;

FIGS. 7a, 7b, 7c and 7d is a cross sectional view of line 7-7 of FIG. 4;

FIG. 8 is an enlarged fragmentary view of an insertable index divider with the tab's bottom edge partially closed;

FIG. 9 is an enlarged fragmentary view of an insertable index divider according to another embodiment;

FIG. 10 is an enlarged fragmentary view of an insertable index divider with a label insert inserted into the tab's pocket;

FIG. 11 is an enlarged fragmentary view of an insertable index divider according to still other embodiment;

FIG. 12 shows a set of insertable divider sheets together with a label insert sheet; and

FIG. 13 is a conventional insertable divider sheet with special tab's opening.

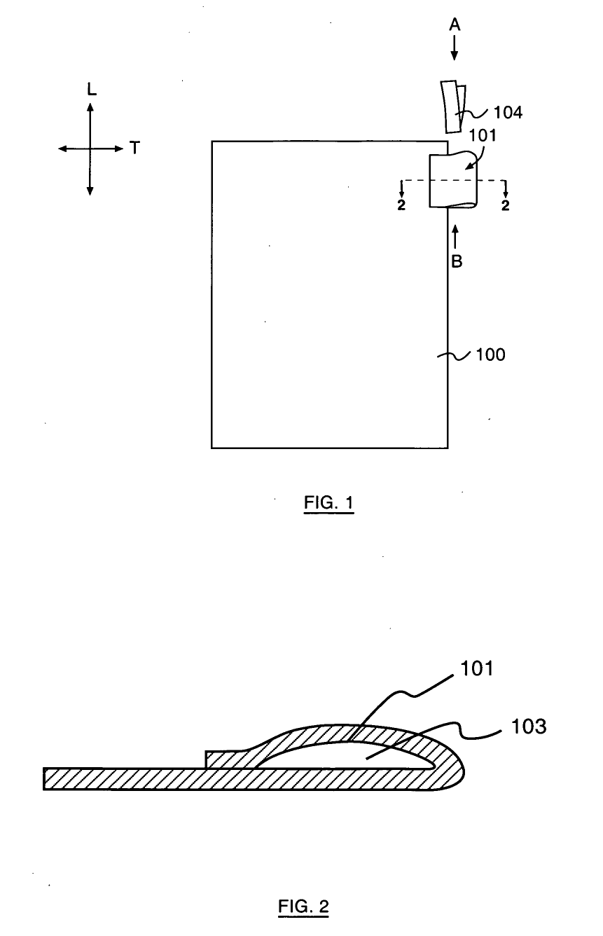

### DETAILED DESCRIPTION OF THE INVENTION

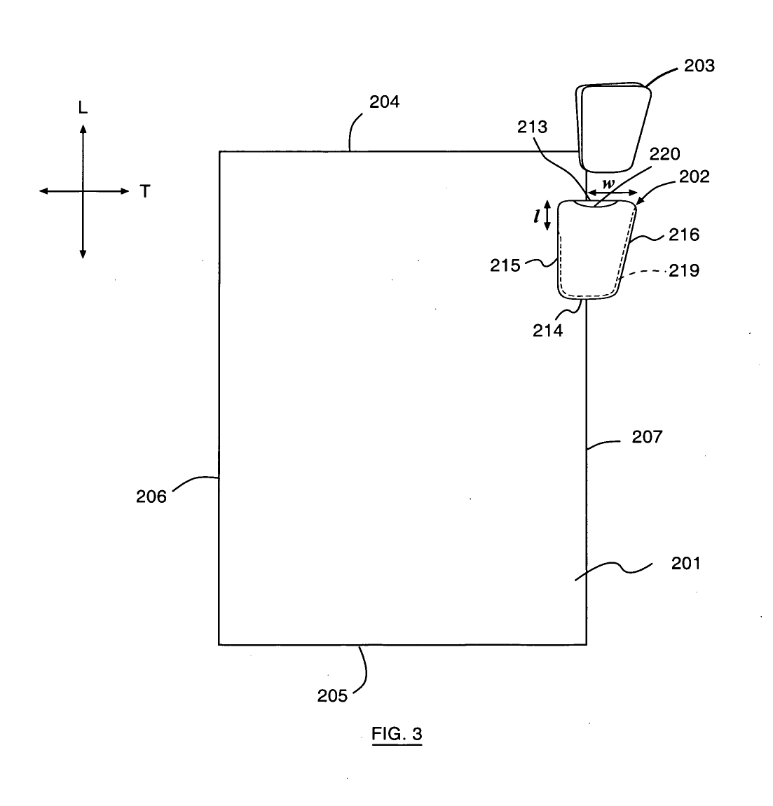

Referring to FIG. 3, the present invention relates to a divider sheet 201 which consists of a label insert 203 and a tab 202 in which the tab's opening is designed specially to ease the insertion and removal of the label insert 203.

The divider sheet 201 has a top edge 204, a bottom edge 205 and a pair of side edges 206 and 207. To simplify this discussion, the direction perpendicular to the top edge 204 of the divider sheet 201 and parallel to the side edges 206 and 207 of the divider sheet 201 will be regarded as the longitudinal direction L while the direction parallel to the top edge 204 of the divider sheet 201 and perpendicular to the side edges 206 and 207 will be regarded as the transverse direction T. The tab 202 may be attached to the divider sheet 201 at one of the side edge 207. The tab 202 may be of any shapes with any number of edges as long as the matching label insert 203 can be fitted in the pocket 217 through the opening 212. In the present embodiment, the tab 202 is rectilinear in shape with a top edge 213, a bottom edge 214, and two edges 215 and 216 adjoining to the top edge 213 and the bottom edge 214.

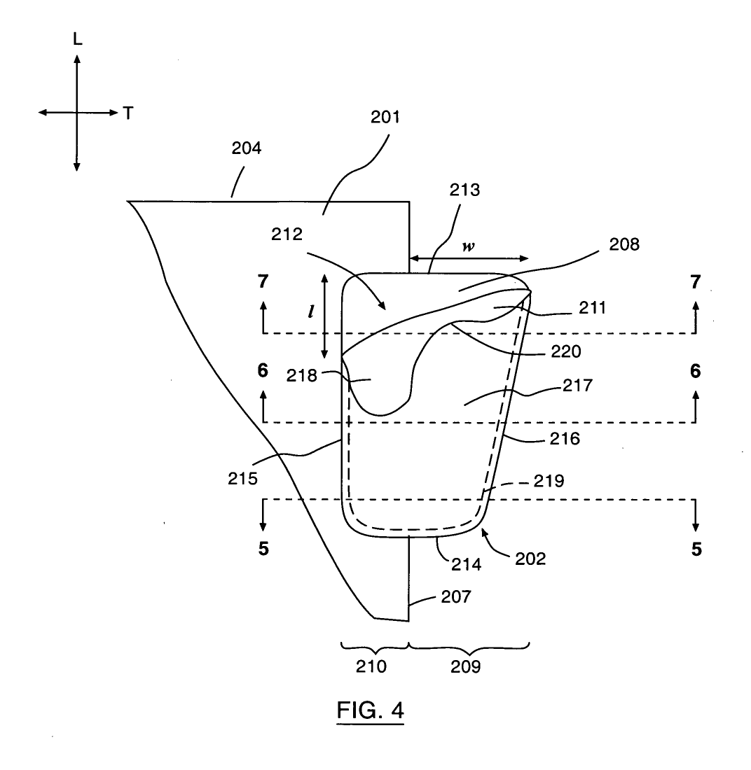

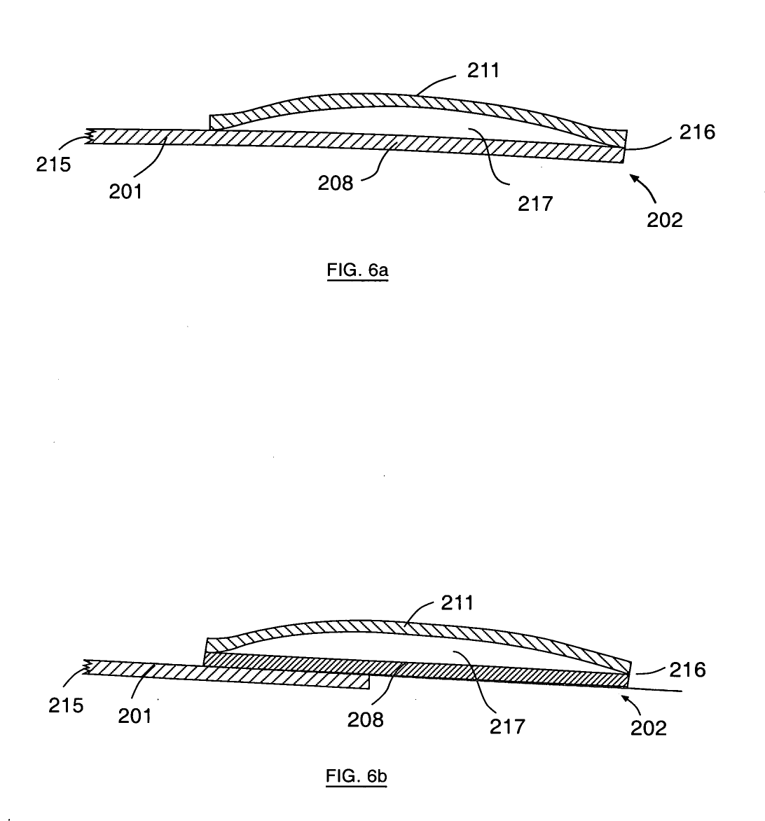

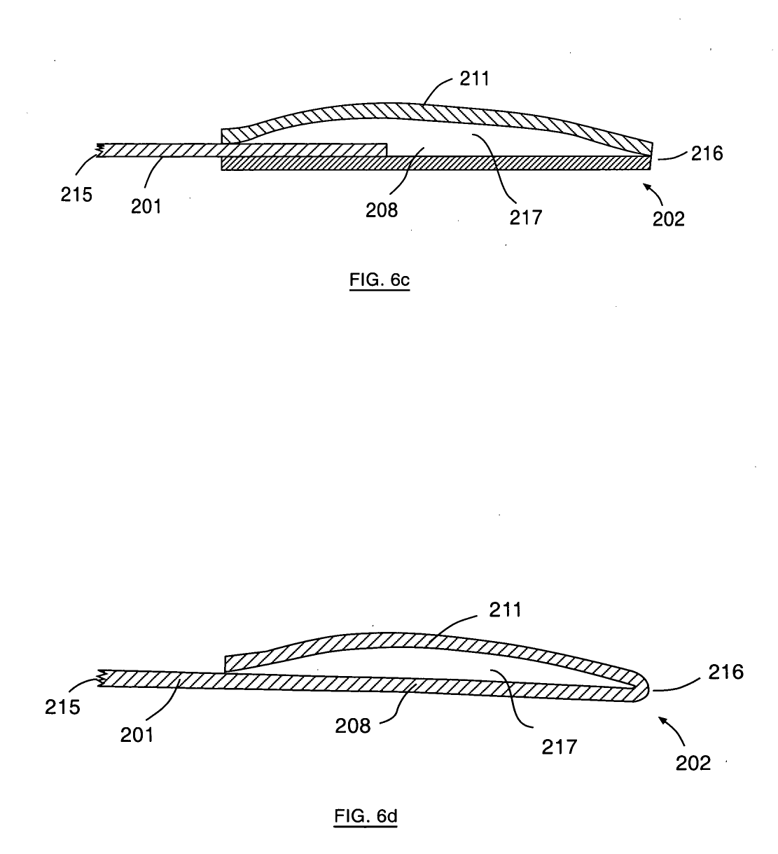

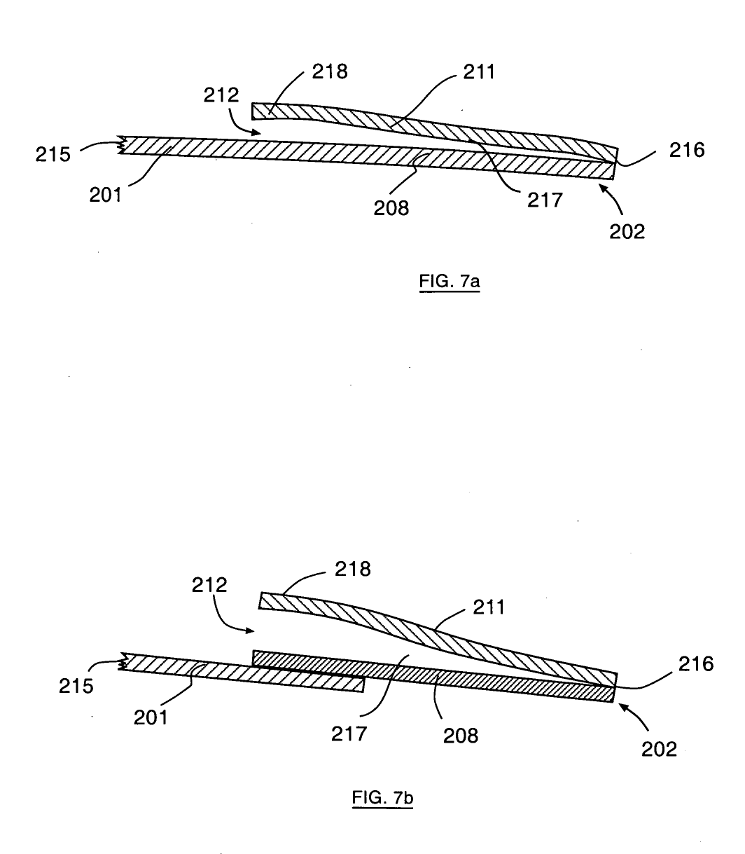

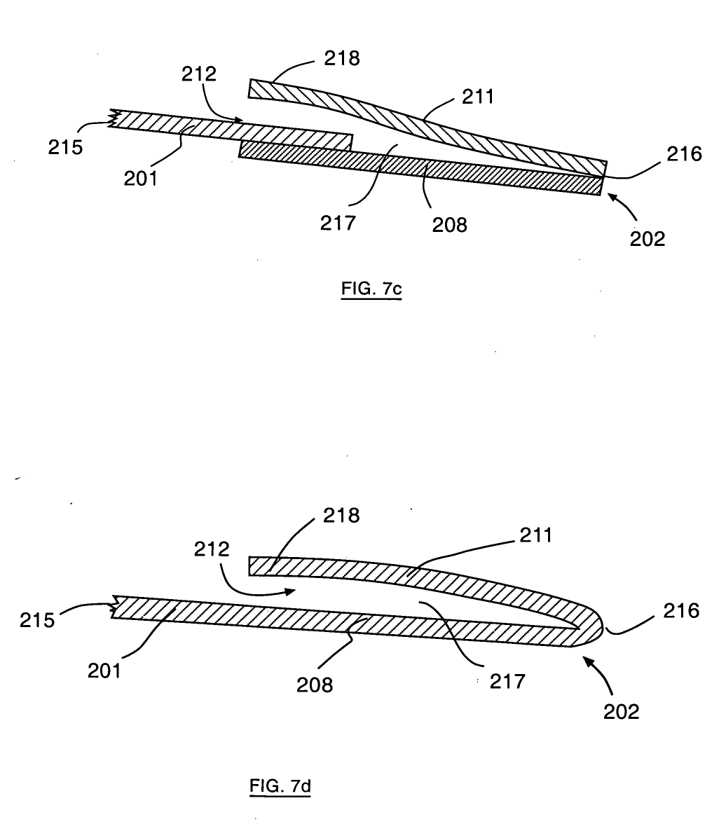

With reference to FIGS. 4, 5, 6 and 7, the tab 202 may comprises of a tab section 208 which has a projecting section 209 that extends out from the side edge 207 and a non projecting section 210 that lies on the divider sheet 201. Also, the tab 202 may comprises of a pocket section 211 that adheres to the tab section 208. The pocket section 211 may includes a notch 220 that guides a user to the site of entry for the tab's pocket 217 as well as eases the opening 212 of the pocket 217 for insertion and removal of a label insert 203. The tab section 208 and the pocket section 211 form a pocket 217 with an opening 212 in the transverse direction T at the top edge 213 of the tab 202 and extending partially along at least one of the edges 215 and 216 adjoining to the opening 212 such that it forms a flap 218 that is able to be flipped open from the divider sheet at the top of the pocket 217's opening 212 which eases the insertion and removal of a label insert 203 into the pocket 217 in the longitudinal direction L. Hence, the sealing of the pocket section 211 onto the tab section 208 defines the dimension of the pocket 217. The pocket section 211 is transparent so that the indicia on the label insert can be easily read through the tab 202.

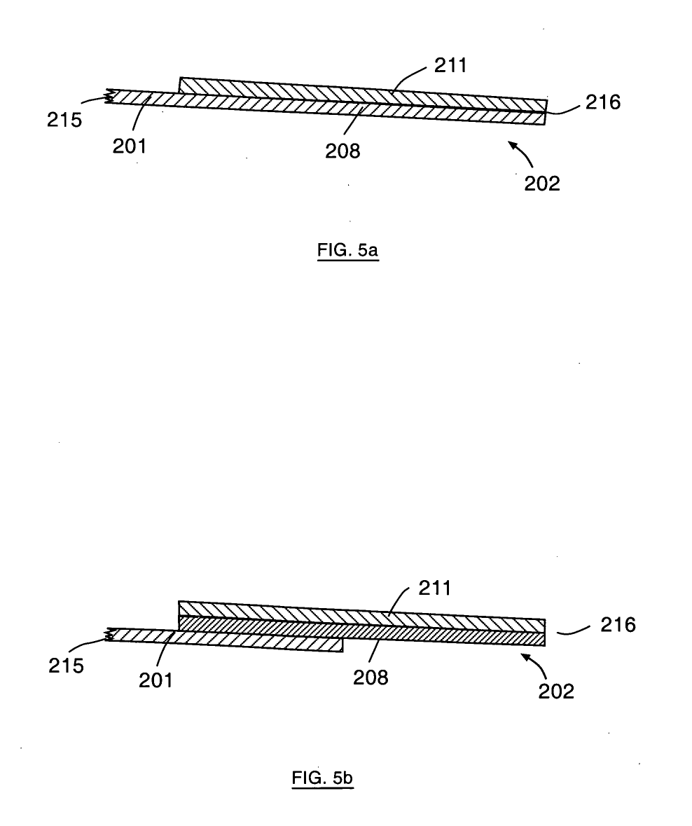

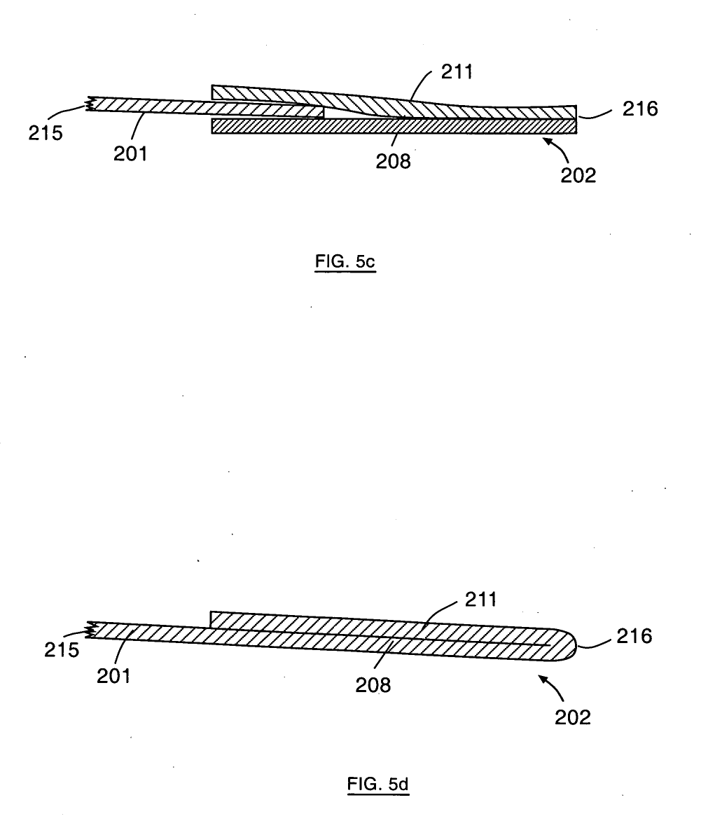

In some of the embodiment, the tab section 208 may be on the same sheet as the divider sheet 201 as illustrated in FIGS. 5a, 6a and 7a. Otherwise, the tab section 208 may be of a separate piece of plastic or other suitable material attached on top or at the bottom of the divider sheet 201 along the side edges 206 and 207 as shown in FIGS. 5b, 5c, 6b, 6c, 7b, and 7c.

Although in the present embodiment as indicated in FIGS. 5b, 5c, 6b, 6c, 7b, and 7c, the tab section 208 and pocket section 211 may be made of two separate pieces of plastic or other suitable material, it is understood that the tab section 208 and pocket section 211 may be made of one same piece of plastic or other suitable material folded about a line to form a pocket 217 and attached to the divider sheet 201.

Alternatively, the tab section 208, the pocket section 211 and the divider sheet 201 are made of the same sheet of plastic or other suitable material as disclosed in FIGS. 5d, 6d and 7d.

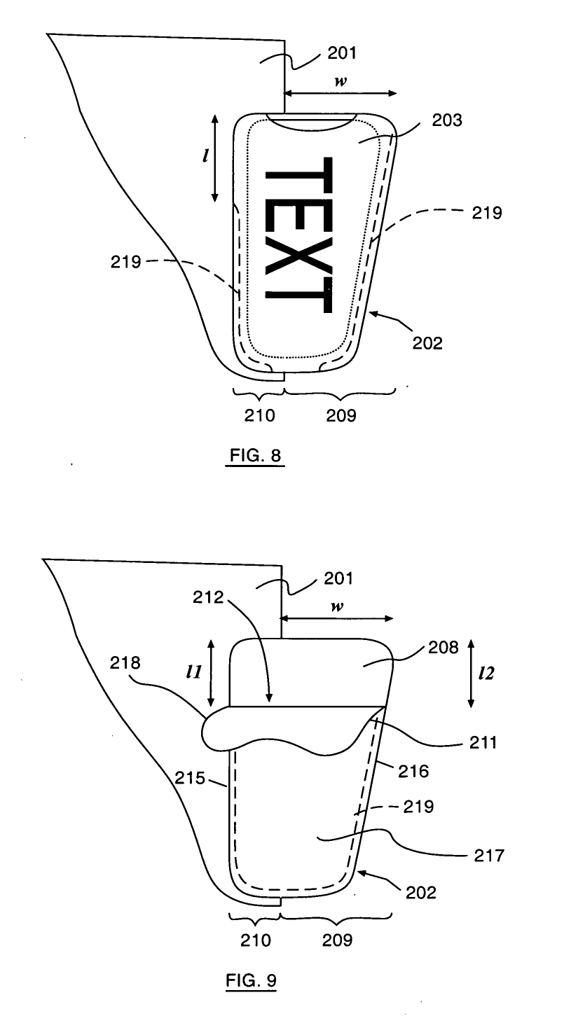

The opening 212 of the tab 202 has a width w in the projection section 209 wider than a length l in the longitudinal direction as indicated in FIGS. 3 and 4. The bottom edge 214 and the edges 215 and 216 adjoining to the bottom edge 214 of the tab 202 may be closed by sealing, welding, ultrasonic or by any other known means up to the opening 212 as indicated by dashed lines 219 in FIGS. 3 and 4 to prevent the label insert 203 from falling out from the tab 202 in the transverse and longitudinal directions. Otherwise, the bottom edge 214 of the tab 202 may be partially closed or of a smaller width compared to the top edge 213 that would prevent the label insert 203 from falling out from the tab 202 as shown in FIG. 8.

In other embodiment as shown in FIG. 9, the tab section 208 and the pocket section 211 may form a pocket 217 with an opening 212 in the transverse direction T at the top of the tab 202 and extending partially along both of the edges 215 and 216 adjoining to the opening 212 such that it forms a flap 218 that is able to be flipped open from the divider sheet at the top of the pocket 217's opening 212. The lengths l₁ and l₂ in the longitudinal direction is shorter than the width w of the projecting section 209.

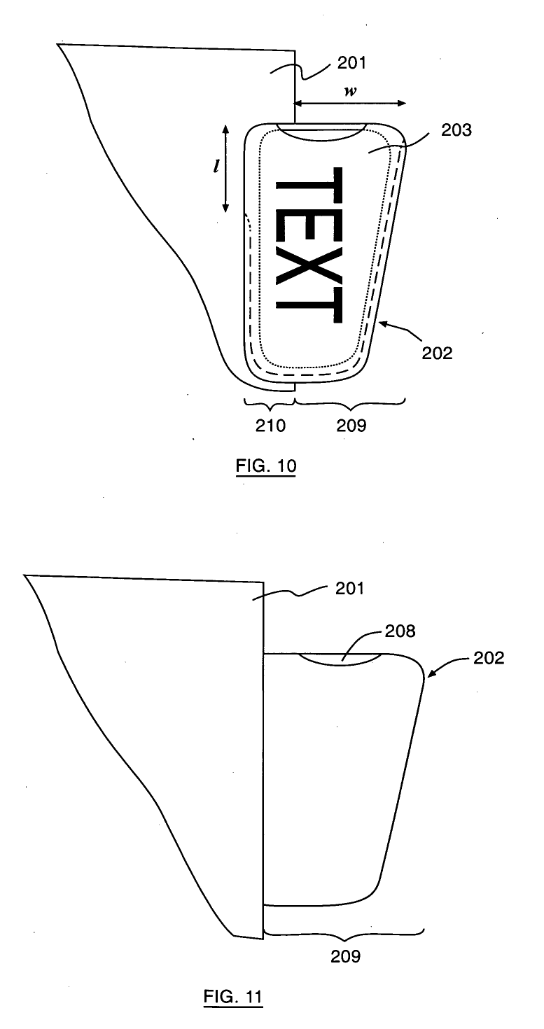

It is shown in FIG. 10 that the label insert 203 may be designed corresponding to the shape of the tab 202 of the divider sheet 201. The text or indicia on the label insert 203 when inserted into the pocket 217 is visible at the projection section 209 and non projecting section 210 of the tab 202. The label insert 203 may be designed with a larger writing or printing area so that the amount of information that can be printed onto the label insert 203 will not be as limited as compared to the conventional insertable divider sheet 100. Also, the dimension of the projecting section 209 may be designed to allow significant amount of information to be visible when the divider sheet 201 is filed between the pages to be indexed inside a ring binder. The divider sheet 201 includes a plurality of holes along one edge for facilitating the filling of the divider sheet 201 in a ring binder.

In some of the embodiments, the tab section 208 may only includes of the projecting section 209 as shown in FIG. 11.

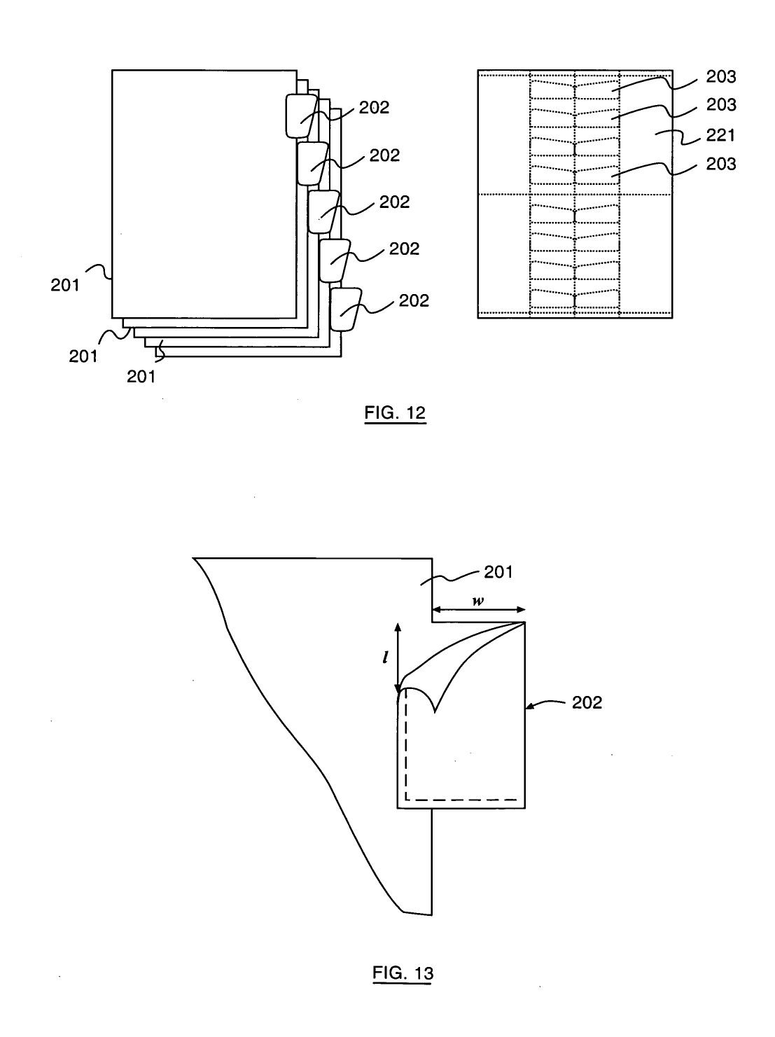

A set of divider sheets may consists of any number of divider sheet 201 with the tab 202 located along one of the side edges 206 and 207 at various positions and a label insert sheet 221 with a plurality of label inserts 203; even though in the present embodiment, the number of divider sheets in a set of divider sheets is 5 as shown in FIG. 12.

In still other embodiment, the design of the tab opening may be applied to the conventional insertable index divider as shown in FIG. 13.

The present invention is not restricted to the embodiments and explanations disclosed in the detailed description of invention. Any person skilled in the art is able of different modifications and alterations to the present invention.

I claim:

1. A divider sheet consists of:
a label insert; and
a divider sheet having:
a top edge, a bottom edge and a pair of side edges with the direction parallel to the top edge defined as the transverse direction and the direction parallel to the side edge defined as the longitudinal direction;
a tab attached to at least one of side edges, the tab includes:
a tab section projecting out from at least one of the side edges in which the tab is attached to; and
a pocket section at least partially adhered to the tab section;
the tab section and the pocket section form a pocket with an opening in the transverse direction at the top of the tab and extending partially along at least one of the edges adjoining to the opening such that it forms a flap that is able to be flipped open from the divider sheet at the top of the pocket's opening which eases the insertion and removal of a label insert into the pocket in the longitudinal direction.

2. The divider sheet of claim 1 wherein the opening of the tab is wider in the transverse direction than in the longitudinal direction.

3. The divider sheet of claim 1 wherein the flap of the pocket has a notch that guides a user to the site of entry for the tab's pocket as well as eases the opening of the pocket for insertion and removal of a label insert.

4. The divider sheet of claim 1 wherein the tab having a tab section that includes a non projecting section and a projecting section.

5. The divider sheet of claim 1 wherein the tab having a tab section that includes a projecting section.

6. The divider sheet of claim 1 wherein the pocket section is transparent so that the indicia on the label insert can be read.

7. The divider sheet of claim 1 wherein the sealing of the pocket section onto the tab section defines the dimension of the pocket.

8. The label insert of claim 1 is designed corresponding to the shape of the tab of the divider sheet.

9. The divider sheet of claim 1 includes of a tab shaped curvilinearly.

10. The divider sheet of claim 1 includes of a tab shaped rectilinearly.

11. The divider sheet of claim 1 wherein the tab is closed at the bottom edge and extending along its adjacent edges to the tab's opening to prevent the label insert from falling out from the tab from the bottom and the sides of the tab.

12. The divider sheet of claim 1 wherein the tab is closed partially at the bottom edge and extending along its adjacent edges to the tab's opening to prevent the label insert from falling out from the tab from the bottom and the sides of the tab.

13. The divider sheet of claim 1 includes a plurality of holes along one edge for facilitating the filling of the divider sheet in a ring binder.

14. A set of divider sheets consist of:
a label insert sheet with a plurality of label inserts; and
a plurality of divider sheets, each divider sheet having:
a top edge, a bottom edge and a pair of side edges with the direction parallel to the top edge defined as the transverse direction and the direction parallel to the side edge defined as the longitudinal direction;
a tab attached to at least one of side edges, the tab includes:
a tab section projecting out from at least one of the side edges in which the tab is attached to; and
a pocket section at least partially adhered to the tab section;
the tab section and the pocket section form a pocket with an opening in the transverse direction at the top of the tab and extending partially along at least one of the edges adjoining to the opening such that it forms a flap that is able to be flipped open from the divider sheet at the top of the pocket's opening which eases the insertion and removal of a label insert into the pocket in the longitudinal direction.
